(19) United States
(12) Patent Application Publication
(10) Pub. No.: US 2022/0379888 A1
(43) Pub. Date: Dec. 1, 2022

(54) Inter-Platooning Vehicle Distance Controller, Vehicle System Including the Same, and Method Thereof

(71) Applicants: Hyundai Motor Company, Seoul (KR); Kia Corporation, Seoul (KR)

(72) Inventor: Jung Wan Kim, Yongin-si (KR)

(21) Appl. No.: 17/490,571

(22) Filed: Sep. 30, 2021

(30) Foreign Application Priority Data
May 25, 2021 (KR) 10-2021-0067224

(51) Int. Cl. B60W 30/16; G08G 1/00; B60W 30/165; B60W 40/13; B60W 10/18; B60T 7/22; B60T 8/32; B60T 8/18

(52) U.S. Cl. CPC B60W 30/162; G08G 1/22; B60W 30/165; B60W 40/13; B60W 10/18; B60T 7/22; B60T 8/321; B60T 8/18; B60W 2510/182; B60W 2520/30; B60W 2520/403; B60T 2201/022

(57) ABSTRACT

An embodiment inter-platooning vehicle distance controller includes a processor configured to separate a linear control section from a non-linear control section based on whether a preceding vehicle brakes during platooning, predict a real-time deceleration for each platooning vehicle with regard to a disturbance factor when generating a deceleration in the linear control section, and set target decelerations of platooning vehicles based on the predicted real-time deceleration, and a memory configured to store data and an algorithm executable by the processor.

### CROSS-REFERENCE TO RELATED APPLICATIONS

This application claims the benefit of Korean Patent Application No. 10-2021-0067224, filed in the Korean Intellectual Property Office on May 25, 2021, which application is hereby incorporated herein by reference.

### TECHNICAL FIELD

The present disclosure relates to an inter-platooning vehicle distance controller, a vehicle system including the same, and a method thereof.

### BACKGROUND

Platooning is performed in a manner where a following vehicle follows behind a preceding vehicle. Vehicles in a platoon transmit and receive a variety of driving information through vehicle-to-vehicle (V2V) communication and control a speed of the vehicle, a vehicle interval, or the like to travel while keeping a certain interval between the vehicles.

To maximize the efficiency of such platooning, an inter-vehicle distance between platooning vehicles should be minimized to minimize cut-in of a general driver and an increase in air resistance. However, when minimizing an inter-vehicle distance, it is difficult to exclude a probability that collision will occur upon emergency braking due to occurrence of a critical situation in front of a host vehicle. Thus, in an existing technology, the amount of maximum braking is limited or an increase in inter-vehicle distance is controlled by predicting a braking distance between vehicles.

However, because such an existing control manner does not consider a difference in a deceleration change rate during a real-time micro-time for a disturbance, such as a non-linear (wheel lock) braking force section where an increase in braking torque does not refer to an increase in vehicle deceleration, a delay in applying a braking force according to hardware (H/W) responsiveness, degradation in braking force due to heat, or a change in weight point of a front/rear axle upon braking, a prediction error of the final braking distance may occur and a collision may occur due to only a deceleration deviation for each vehicle in a micro-time during high-speed braking although there is no braking section error and the same distance moves. Thus, it is unable to decrease an inter-vehicle distance to a minimum region.

### SUMMARY

The present disclosure relates to an inter-platooning vehicle distance controller, a vehicle system including the same, and a method thereof. Particular embodiments relate to technologies of minimizing an inter-vehicle distance between platooning vehicles with regard to a braking distance between the platooning vehicles.

Embodiments of the present disclosure can solve problems occurring in the prior art while advantages achieved by the prior art are maintained intact.

An embodiment of the present disclosure provides an inter-platooning vehicle distance controller for predicting a real-time vehicle deceleration using deceleration (Ax) as a control reference factor for reducing a braking distance of a platooning vehicle and controlling a pressure control valve for braking to minimize an inter-vehicle distance between platooning vehicles, a vehicle system including the same, and a method thereof.

The technical problems to be solved by embodiments of the present disclosure are not limited to the aforementioned problems, and any other technical problems not mentioned herein will be clearly understood from the following description by those skilled in the art to which the present disclosure pertains.

According to an embodiment of the present disclosure, an inter-platooning vehicle distance controller may include a processor that separates a linear control section from a non-linear control section depending on whether a preceding vehicle brakes during platooning, predicts a real-time deceleration for each platooning vehicle with regard to a disturbance factor when generating a deceleration in the linear control section, and sets target decelerations of platooning vehicles based on the predicted real-time deceleration and a memory storing data and an algorithm run by the processor.

In an embodiment, the processor may determine the linear control section where deceleration increases when pressure increases, when an anti-lock brake system (ABS) of the preceding vehicle is turned off, and may determine the non-linear control section where the deceleration does not increase although the pressure increases, when the ABS of the preceding vehicle is turned on.

In an embodiment, the processor may predict the deceleration using at least one of information indicating whether a platooning vehicle decelerates, an ABS flag of the platooning vehicle, information about a vehicle weight of the platooning vehicle (including a front/rear axle), information about a disk temperature of the platooning vehicle, or information about a required deceleration of the platooning vehicle and may set the target deceleration based on the predicted deceleration.

In an embodiment, the processor may calculate a delay of a time taken to generate a braking pressure for each vehicle, in the linear control section.

In an embodiment, the processor may convert the braking pressure for each vehicle into a braking torque to calculate braking torque conversion efficiency.

In an embodiment, the processor may apply an ideal braking diagram to the braking torque to limit torques of a front wheel and a rear wheel and may predict the deceleration.

In an embodiment, the processor may multiply the braking torque by braking efficiency according to pressure for each brake pad temperature to calculate the braking torque conversion efficiency.

In an embodiment, the processor may calculate a delay time of an actual vehicle deceleration compared to a required deceleration according to a vehicle weight.

In an embodiment, the processor may predict real-time decelerations of the platooning vehicles using at least one of a braking pressure generation delay time for each vehicle, the efficiency of generating the braking torque, or a deceleration arrival delay time for each vehicle weight.

In an embodiment, the processor may set the smallest value among real-time decelerations of the platooning vehicles to the target decelerations of the platooning vehicles.

In an embodiment, the processor may set the target decelerations of the platooning vehicles to the same value.

In an embodiment, the processor may set a deceleration of the preceding vehicle to a target deceleration of a host vehicle, in the non-linear control section, may add an offset to a target deceleration of the preceding vehicle, and may subtract the offset from a target deceleration of a following vehicle to set the target decelerations of the platooning vehicles.

In an embodiment, the processor may control an inter-vehicle distance between the preceding vehicle and a host vehicle in a direction where the inter-vehicle distance increases, in the non-linear control section.

In an embodiment, the processor may calculate a required torque of a front wheel and a required torque of a rear wheel based on an ideal braking diagram for a target deceleration, may calculate a required pressure for the required torque considering braking efficiency of a brake pad, may calculate a real-time pressure for the required pressure, and may predict a real-time deceleration for each platooning vehicle using the calculated real-time pressure value.

In an embodiment, the memory may store a braking pressure generation delay time mapping value for each vehicle, a braking torque mapping value for each pressure, or a deceleration arrival delay time mapping value for each vehicle weight.

In an embodiment, the processor may obtain a delay of a time taken to generate a braking pressure for each vehicle from the braking pressure generation delay time mapping value for each vehicle and may obtain a deceleration arrival delay time for each vehicle weight from the deceleration arrival delay time mapping value for each vehicle weight.

In an embodiment, the disturbance factor may include at least one of a non-linear braking force section where an increase in braking torque does not refer to an increase in vehicle deceleration, a delay in applying a braking force according to hardware responsiveness, degradation in braking force due to heat, or a change in weight points of a front axle and a rear axle of a vehicle upon braking.

According to another embodiment of the present disclosure, a vehicle system may include an inter-platooning vehicle distance controller that separates a linear control section from a non-linear control section depending on whether a preceding vehicle brakes during platooning, predict a real-time deceleration for each platooning vehicle with regard to a disturbance factor when generating a deceleration in the linear control section, and sets target decelerations of platooning vehicles based on the predicted real-time deceleration and a pressure control valve that is controlled by the inter-platooning vehicle distance controller to control an air pressure applied from an air tank to a disk.

According to another embodiment of the present disclosure, an inter-platooning vehicle distance control method may include separating a linear control section from a non-linear control section depending on whether a preceding vehicle brakes during platooning, predicting a real-time deceleration for each platooning vehicle with regard to a disturbance factor when generating a deceleration in the linear control section, and setting target decelerations of platooning vehicles based on the predicted real-time deceleration.

In an embodiment, the separating of the linear control section from the non-linear control section may include determining the linear control section where deceleration increases when pressure increases, when an anti-lock brake system (ABS) of the preceding vehicle is turned off, and determining the non-linear control section where the deceleration does not increase although the pressure increases, when the ABS of the preceding vehicle is turned on.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a block diagram illustrating a configuration of a vehicle system including an inter-platooning vehicle distance controller according to an embodiment of the present disclosure;

FIG. 2 is a drawing illustrating an apparatus for inter-platooning vehicle distance control according to an embodiment of the present disclosure;

FIG. 3 is a schematic diagram illustrating an inter-platooning vehicle distance control method according to an embodiment of the present disclosure;

FIG. 4 is a drawing illustrating in detail the inter-platooning vehicle distance control method in FIG. 3;

FIG. 5 is a flowchart illustrating in detail the inter-platooning vehicle distance control method in FIG. 4;

FIGS. 6A and 6B are drawings illustrating a process of calculating a delay in generating a braking pressure according to an embodiment of the present disclosure;

FIGS. 7A and 7B are drawings illustrating a process of calculating the efficiency of generating a braking torque according to an embodiment of the present disclosure;

FIGS. 8A and 8B are drawings illustrating a process of calculating a delay in generating a vehicle deceleration according to an embodiment of the present disclosure;

FIG. 9 is a drawing illustrating a process of calculating a safety deceleration (Ax) offset according to an embodiment of the present disclosure;

FIG. 10 is a schematic drawing illustrating a linear and non-linear control process according to an embodiment of the present disclosure;

FIG. 11 is a schematic drawing illustrating a process of setting a target deceleration according to an embodiment of the present disclosure;

FIGS. 12 and 13 are drawings illustrating a process of controlling an operation of a pressure control valve for following a target deceleration according to an embodiment of the present disclosure; and

FIG. 14 is a block diagram illustrating a computing system according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

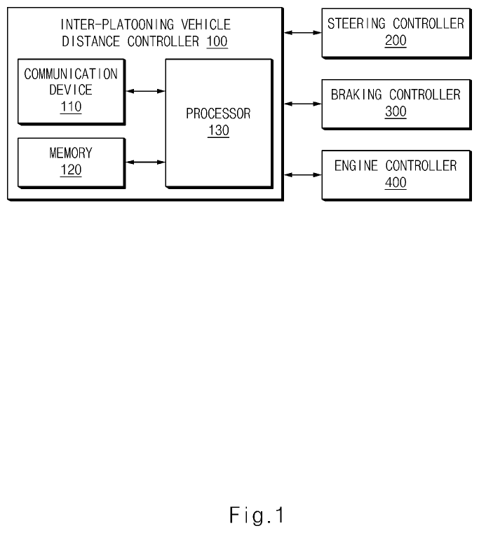

Hereinafter, embodiments of the present disclosure will be described in detail with reference to FIGS. 1 to 14.

FIG. 1 is a block diagram illustrating a configuration of a vehicle system including an inter-platooning vehicle distance controller according to an embodiment of the present disclosure.

Referring to FIG. 1, the vehicle system according to an embodiment of the present disclosure may include an inter-platooning vehicle distance controller 100, a steering controller 200, a braking controller 300, and an engine controller 400.

The inter-platooning vehicle distance controller 100 according to an embodiment of the present disclosure may be implemented in a vehicle. In this case, the inter-platooning vehicle distance controller 100 may be integrally configured with control units in the vehicle or may be implemented as a separate device to be connected with the control units of the vehicle by a separate connection means.

The inter-platooning vehicle distance controller 100 may separate a linear control section from a non-linear control section depending on whether a preceding vehicle brakes during platooning, may predict a real-time deceleration for each platooning vehicle with regard to a disturbance factor when generating a deceleration in the linear control section, and may control a speed of a platooning vehicle based on the predicted real-time deceleration. In this case, the disturbance factor may include at least one of a non-linear braking force section where an increase in braking torque does not refer to an increase in vehicle deceleration, a delay in applying a braking force according to hardware responsiveness, degradation in braking force due to heat, or a change in weight points of a front axle and a rear axle of the vehicle upon braking.

In other words, when a pressure control valve command is applied to a pressure control valve, the generation of pressure is delayed. Corresponding pressure is converted into a braking torque, and the vehicle follows the braking torque to decelerate. Deceleration occurs through a certain delay depending on a weight of the vehicle.

Thus, the inter-platooning vehicle distance controller 100 may calculate a delay in generating pressure, may calculate the efficiency of generating a braking torque, and may calculate an actual vehicle deceleration delay time compared to a required acceleration according to a weight of the vehicle, thus predicting a deceleration for each platooning vehicle.

Referring to FIG. 1, the inter-platooning vehicle distance controller 100 may include a communication device 110, a memory (i.e., a storage) 120, and a processor 130.

The communication device 110 may be a hardware device implemented with various electronic circuits to transmit and receive a signal through a wired connection, which may transmit and receive information with devices in the vehicle based on a network communication technology in the vehicle. As an example, the network communication technology in the vehicle may include controller area network (CAN) communication, local interconnect network (LIN) communication, flex-ray communication, or the like. As an example, the communication device 110 may transmit a valve control command signal to a pressure control valve.

The memory 120 may store data, an algorithm, and/or the like necessary for an operation of the processor 130. As an example, the memory 120 may store a braking pressure generation delay time mapping value for each vehicle, a braking torque mapping value for each pressure, a deceleration arrival delay time mapping value for each vehicle weight, or the like. The braking pressure generation delay time mapping value for each vehicle, the braking torque mapping value for each pressure, the deceleration arrival delay time mapping value for each vehicle weight, or the like may be obtained and stored in advance by means of experimental values, measurement values, or the like.

The memory 120 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The processor 130 may be electrically connected with the communication device 110, the memory 120, or the like and may electrically control the respective components. The processor 130 may be an electrical circuit which executes instructions of software and may perform a variety of data processing and calculation described below.

The processor 130 may process a signal delivered between the respective components of the inter-platooning vehicle distance controller 100 and may perform the overall control such that the respective components may normally perform their own functions.

The processor 130 may be implemented in the form of hardware, may be implemented in the form of software, or may be implemented in the form of a combination thereof. Preferably, the processor 130 may be implemented as a microprocessor and may be, for example, an electronic control unit (ECU), a micro controller unit (MCU), or another sub-controller, which is loaded into the vehicle.

The processor 130 may separate a linear control section from a non-linear control section depending on whether a preceding vehicle brakes during platooning, may predict a real-time deceleration for each platooning vehicle with regard to a disturbance factor when generating a deceleration in the linear control section, and may set target decelerations of platooning vehicles based on the predicted real-time deceleration.

The processor 130 may determine a linear control section where deceleration increases when pressure increases, when an anti-lock brake system (ABS) of a preceding vehicle is turned off, and may determine a non-linear control section where deceleration does not increase although pressure increases, when the ABS of the preceding vehicle is turned on.

The processor 130 may predict a deceleration using at least one of information indicating whether a platooning vehicle decelerates, an ABS flag of the platooning vehicle, information about a vehicle weight of the platooning vehicle (including a front/rear axle), information about a disk temperature of the platooning vehicle, or information about a required deceleration of the platooning vehicle and may set a target deceleration based on the predicted deceleration.

The processor 130 may calculate a delay of a time taken to generate a braking pressure for each vehicle, in the linear control section, and may convert the braking pressure for each vehicle into a braking torque to calculate braking torque conversion efficiency. The processor 130 may apply an ideal braking diagram to the braking torque to limit torques of the front wheel and the rear wheel and may predict the deceleration.

The processor 130 may multiply the braking torque by braking efficiency according to pressure for each brake pad temperature to calculate braking torque conversion efficiency in the linear control section and may calculate a delay time of an actual vehicle deceleration compared to a required deceleration according to a vehicle weight.

The processor 130 may predict real-time decelerations of platooning vehicles using at least one of a braking pressure generation delay time for each vehicle, the efficiency of generating a braking torque, or a deceleration arrival delay time for each vehicle weight.

The processor 130 may set the smallest value among the real-time decelerations of the platooning vehicles in the linear control section to target decelerations of the platooning vehicles.

The processor 130 may set the target decelerations of the platooning vehicles to the same value in the linear control section, may set a deceleration of a preceding vehicle to a target deceleration of a host vehicle in the non-linear control section, and may set the target decelerations of the platooning vehicles by adding an offset to the target deceleration of the preceding vehicle and subtracting the offset from the target deceleration of a following vehicle.

The processor 130 may control an inter-vehicle distance between the preceding vehicle and the host vehicle in a direction where the inter-vehicle distance increases, in the non-linear control section.

The processor 130 may calculate a torque required for each of the front wheel and the rear wheel based on the ideal braking diagram for a target deceleration, may calculate a required pressure for the required torque considering braking efficiency of a brake pad, and may calculate a real-time pressure for the required pressure, thus predicting a real-time deceleration for each platooning vehicle using the calculated real-time pressure value.

The processor 130 may obtain a delay of a time taken to generate a braking pressure for each vehicle from the braking pressure generation delay time mapping value for each vehicle, which is stored in the memory 120, and may obtain a deceleration arrival delay time for each vehicle weight from the deceleration arrival delay time mapping value for each vehicle weight.

The processor 130 may open the pressure control valve using a maximum value, for a vehicle causing a minimum deceleration among platooning vehicles, and may open the pressure control valve using a minimum value, when a vehicle capable of generating an additional deceleration among the platooning vehicles is limited, thus controlling the real-time decelerations of the platooning vehicles in the same manner.

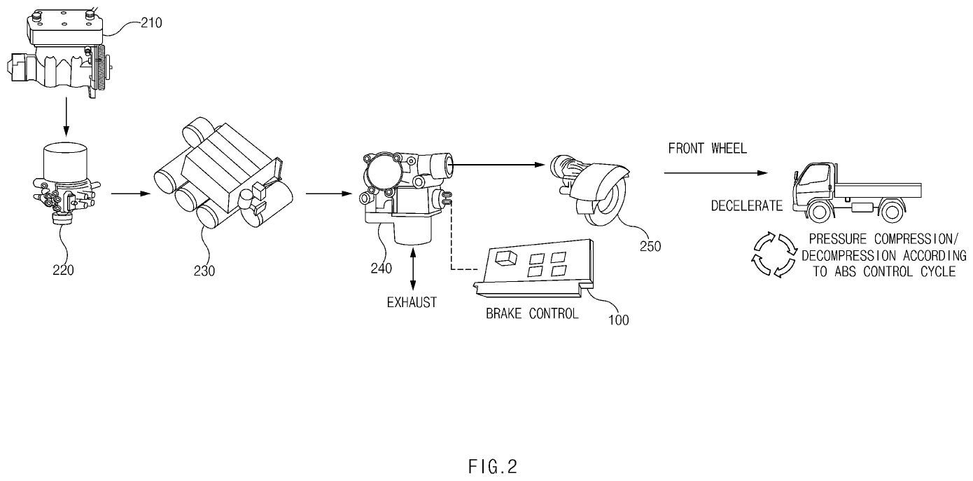

FIG. 2 is a drawing illustrating an apparatus for inter-platooning vehicle distance control according to an embodiment of the present disclosure.

Referring to FIG. 2, a vehicle system for braking of a platooning vehicle for control such as acceleration, deceleration, or braking, to control a distance between platooning vehicles may include an air compressor 210, an air dryer 220, an air tank 230, an inter-platooning vehicle distance controller 100, a pressure control valve 240, and a disk 250.

The air compressor 210 may generate an air pressure for braking. As the air pressure is stored in the air tank 230 through the air dryer 220 and as the air pressure stored in the air tank 230 is applied to the pressure control valve 240 through an air line to be delivered to the disk 250 of each wheel of the vehicle, braking may be performed.

In this case, after passing through disturbance 1 in the process of generating pressure during braking control, disturbance 2 in the process of converting pressure into a required braking torque, and disturbance 3 in the process where a braking torque for each axle is reflected in the vehicle for a desired deceleration depending on a vehicle state, in addition, there may occur disturbance 4 in the ABS control in the non-linear section where a braking force above a loader does not increase when pressure is applied.

Thus, it is possible to only perform a general inter-vehicle distance when a braking distance is controlled without a detailed technical supplement of each of disturbances 1 to 4, and it is difficult to control to minimize an inter-vehicle distance.

Although final movement distances of two vehicles match 100% while a braking force occurs, when a weight of a following vehicle is heavier than that of a preceding vehicle or when deceleration entry parallax occurs due to disturbance by degradation in brake pad or the like, a collision between the preceding vehicle and the following vehicle may occur.

Thus, when disturbance is not considered in advance, a breaking pressure is applied to the preceding vehicle and the following vehicle up to the limit of certain braking force at the same time, and vehicle longitudinal deceleration motion fails to be generated at the same time. For example, when vehicle A is heavier than vehicle B, vehicle A may follow the same deceleration target later than vehicle B, and vehicle A may collide with vehicle B. Furthermore, when the efficiency of generating a braking torque is low because a brake pad temperature of vehicle B is higher than that of vehicle A, vehicle B follows the same deceleration target later than vehicle A because it should increase pressure up to a higher braking pressure for a deceleration target.

Thus, after a distance deviation occurs initially or during braking, in addition, the final braking distances may be controlled to be the same as each other by feedback control of maintaining a braking distance for each vehicle. However, a micro-time is taken until a behavior such as deceleration occurs by reflecting a braking force for correcting a difference between braking distances in the real vehicle. For example, when the micro-time is defined as 0.1 s, it is a time when the vehicle (=30 m/s) of a speed of 108 kph may be as close as a distance of 3 m. Accordingly, it may be difficult to maintain a distance of 4 m to 5 m including a safety ratio, and platooning above the distance may fail to ensure efficiency and cut-in prevention.

Thus, an embodiment of the present disclosure may minimize an interval with a preceding vehicle during a braking time by means of the same real-time deceleration control between platooning vehicles.

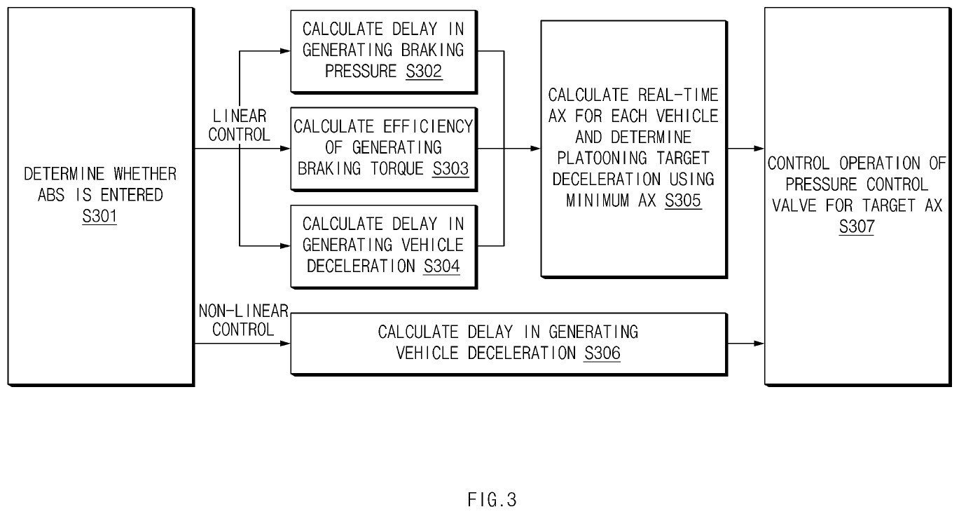

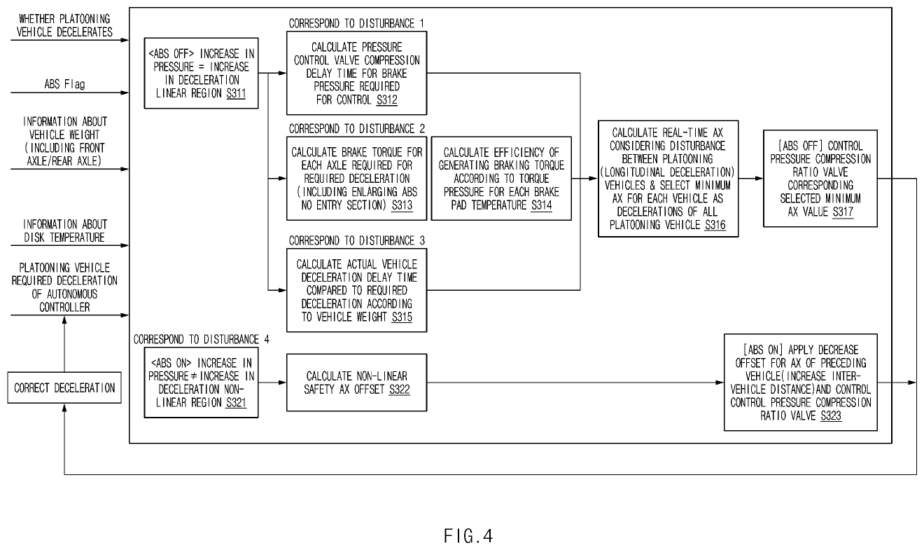

FIG. 3 is a schematic diagram illustrating an inter-platooning vehicle distance control method according to an embodiment of the present disclosure. FIG. 4 is a drawing illustrating in detail the inter-platooning vehicle distance control method in FIG. 3.

Referring to FIG. 3, in S301, an inter-platooning vehicle distance controller 100 of FIG. 1 may determine whether a preceding vehicle enters an ABS (whether the preceding vehicle performs ABS braking) to separate a linear control section from a non-linear control section.

In other words, in general, when a braking pressure increases by means of the brake, a deceleration of the vehicle increases due to an increase in braking torque. However, when a braking force operates above the limit of the road surface, for example, when the road surface is slippery, as a tire lock occurs and the ABS is driven, it is able to ensure safety of the vehicle. However, in this case, deceleration may not be controlled in a linear manner any longer by means of a level of the braking force. Thus, the inter-platooning vehicle distance controller 100 may determine whether the vehicle enters the ABS to determine whether to apply linear control of platooning to the vehicle or whether to apply non-linear control of platooning control to the vehicle.

In other words, the inter-platooning vehicle distance controller 100 may apply the non-linear control to the vehicle, when the vehicle enters the ABS, and may apply the linear control to the vehicle, when the vehicle does not enter the ABS.

In other words, when ABS braking of a preceding vehicle is turned off, the inter-platooning vehicle distance controller 100 may calculate a delay of a time taken to generate a braking pressure for linear control in S302, may calculate the efficiency of generating a braking torque in S303, and may calculate a delay of a time taken to generate a vehicle deceleration in S304.

The inter-platooning vehicle distance controller 100 may perform control of a linear section where a braking force increases when pressure is applied, may consider disturbances 1 to 3 in advance when the deceleration is generated to predict a real-time deceleration for each platooning vehicle, and may calculate a target speed of the platooning vehicle using a minimum value of the real-time deceleration capable of decelerating between vehicles using the values calculated in S302, S303, and S304.

The inter-platooning vehicle distance controller 100 may multiply the efficiency of generating the braking torque by a braking pressure generation delay time for each vehicle, which is limited by an ideal braking diagram generated after the pressure control valve operates to follow the target deceleration and may add a deceleration arrival delay time for each vehicle weight to the multiplied value to predict the real-time deceleration.

The inter-platooning vehicle distance controller 100 may predict a real-time deceleration of each of the platooning vehicles and may set the smallest deceleration among the predicted real-time decelerations to a target deceleration of each of all the platooning vehicles to maintain the same real-time deceleration without a deviation between the vehicles.

On the other hand, when the ABS braking of the preceding vehicle is turned on, in S306, the inter-platooning vehicle distance controller 100 may calculate a non-linear safety deceleration offset.

Thereafter, the inter-platooning vehicle distance controller 100 may control a pressure control valve of each vehicle to follow the real-time deceleration calculated in S305, when the vehicle does not enter the ABS, and may apply the deceleration offset to control the pressure control valve in a direction where the inter-vehicle distance increases to follow the deceleration of the preceding vehicle and the following vehicle, which enter the ABS, when the vehicle enters the ABS.

In other words, the target decelerations obtained through the linear control may be set to the same value such that all the platooning vehicles travel in the same manner. The target deceleration obtained by means of the non-linear control may have a different correction value for each vehicle. Each vehicle estimates its own target deceleration. Thus, the inter-platooning vehicle distance controller 100 may control a braking pressure control valve as an actuator to control a pressure generation slope by means of short on/off repetition.

When the target deceleration is corrected in S317 to S323, the corrected target deceleration may be fed back and reflected in a platooning vehicle required deceleration of an autonomous controller.

A description will be given in detail of each process of FIG. 3 with reference to FIG. 4.

The inter-platooning vehicle distance controller 100 may perform inter-vehicle distance control using at least one of information indicating whether a platooning vehicle decelerates, an ABS flag of the platooning vehicle, information about a vehicle weight of the platooning vehicle (including a front/rear axle), information about a disk temperature of the platooning vehicle, or information about a required deceleration of the platooning vehicle.

The inter-platooning vehicle distance controller 100 may determine whether the ABS is turned on/off using the information about the ABS flag. When the ABS is turned off, in S311, the inter-platooning vehicle distance controller 100 may determine a linear control section. When the ABS is turned on, in S321, the inter-platooning vehicle distance controller 100 may determine a non-linear control section.

In S312, the inter-platooning vehicle distance controller 100 may calculate a pressure control valve compression delay time for a brake pressure required for control.

In S313, the inter-platooning vehicle distance controller 100 may calculate a braking torque for each axle required for a required deceleration (including enlarging an ABS no entry section). In S314, the inter-platooning vehicle distance controller 100 may calculate the efficiency of generating the braking torque according to a pressure for each brake pad temperature.

In S315, the inter-platooning vehicle distance controller 100 may calculate an actual vehicle deceleration delay time compared to a required deceleration according to a vehicle weight.

In S316, the inter-platooning vehicle distance controller 100 may calculate a real-time deceleration considering a disturbance between platooning vehicles and may set a minimum deceleration among decelerations for every vehicle to a target deceleration of each of all platooning vehicles.

In S317, the inter-platooning vehicle distance controller 100 may control a pressure control valve for adjusting a pressure compression ratio to follow the target deceleration set to the minimum deceleration.

Meanwhile, in S322, the inter-platooning vehicle distance controller 100 may calculate a non-linear safety deceleration offset for the non-linear control in S321.

In S323, the inter-platooning vehicle distance controller 100 may apply a decrease offset for decreasing a deceleration of a preceding vehicle and may apply an increase offset for increasing a deceleration of a following vehicle to set a target deceleration for each vehicle and may control a pressure control valve to suit the target deceleration.

As such, an embodiment of the present disclosure may reduce an inter-vehicle distance between platooning vehicles to minimize cut-in of a general driver and an increase in air resistance.

In other words, an embodiment of the present disclosure may predict and correct a deceleration generated when the vehicle brakes in real time to ensure the same braking motion of the vehicle before platooning. Particularly, an embodiment of the present disclosure may separate a section (a linear section) capable of maintaining linearity of deceleration using braking control and a section (a non-linear section) incapable of maintaining the linearity of the deceleration and may further reduce a possibility of collision, thus extremely reducing an inter-vehicle distance and increasing competitiveness of a commercial platooning vehicle.

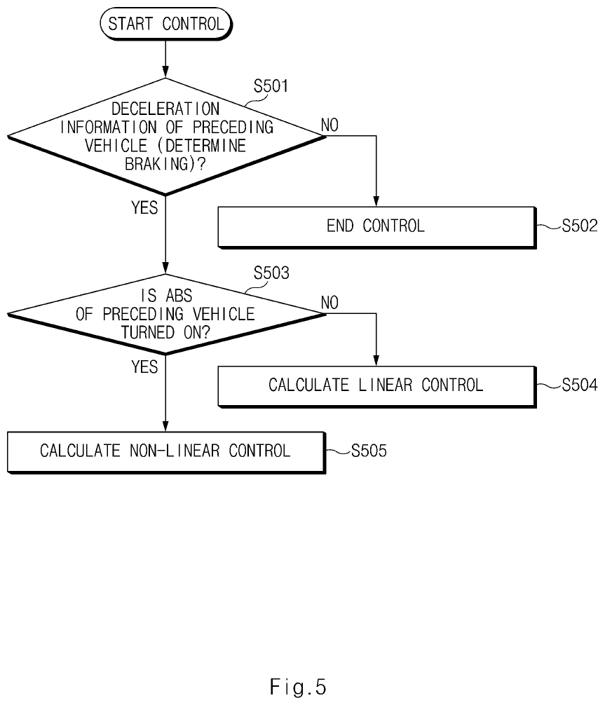

Hereinafter, a description will be given in detail of an inter-platooning vehicle distance control method according to an embodiment of the present disclosure with reference to FIG. 5. FIG. 5 is a flowchart illustrating in detail the inter-platooning vehicle distance control method in FIG. 4.

Hereinafter, it is assumed that an inter-platooning vehicle distance controller 100 in FIG. 1 performs a process of FIG. 5. Furthermore, in a description of FIG. 5, an operation described as being performed by the inter-platooning vehicle distance controller 100 may be understood as being controlled by a processor 130 of the inter-platooning vehicle distance controller 100.

Referring to FIG. 5, in S501, the inter-platooning vehicle distance controller 100 may determine deceleration information of a preceding vehicle, that is, whether the preceding vehicle brakes.

When the preceding vehicle does not brake, in S502, the inter-platooning vehicle distance controller 100 may end the control. When the preceding vehicle brakes, in S503, the inter-platooning vehicle distance controller 100 may determine whether the ABS of the preceding vehicle is turned on/off.

When the ABS of the preceding vehicle is turned off, in S504, the inter-platooning vehicle distance controller 100 may perform calculation for linear control. When the ABS of the preceding vehicle is turned on, in S505, the inter-platooning vehicle distance controller 100 may perform calculation for non-linear control. In this case, the calculation for the linear control may include calculation of a delay in generating a braking pressure, calculation of the efficiency of generating a braking torque, calculation of a delay in generating a vehicle deceleration, or the like. Furthermore, the calculation for the non-linear control may include calculation of a safety deceleration offset.

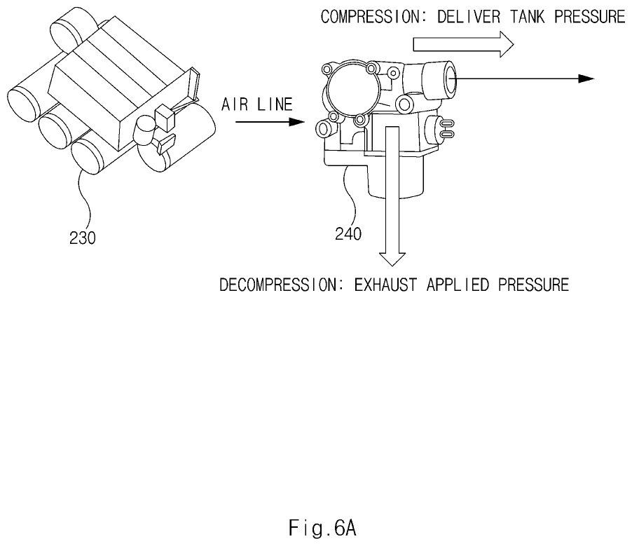

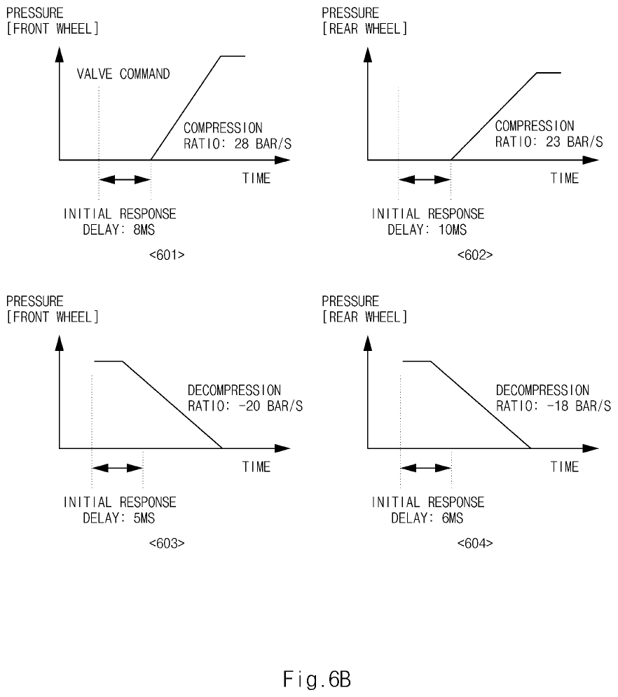

FIGS. 6A and 6B are drawings illustrating a process of calculating a delay in generating a braking pressure according to an embodiment of the present disclosure.

As shown in FIG. 6A, a large commercial vehicle may adjust a braking force using an air pressure to compress or decompress a level of pressure supplied from an air tank 230 through a pressure control valve 240. In this case, pressure generation responsiveness may vary with an air pressure of an air line mounted on the real vehicle, a length of the air line, a diameter of the air line, or a bent degree of the air line according to vehicle specifications when the air line is connected to the front wheel and the rear wheel through the vehicle body frame.

A delay time until pressure is generated after a valve control command in the real vehicle state and a compression fluctuation rate or a decompression fluctuation rate of the pressure may be measured in advance for each axle and be mapped to each other as shown in FIG. 6B to use a real-time prediction value which is faster and more accurate than a measurement value after pressure is generated upon the valve command.

Reference numeral 601 of FIG. 6B indicates the initial response delay after the valve command of the front wheel upon compression, and reference numeral 602 of FIG. 6B indicates the initial response delay after the valve command of the rear wheel upon compression. Reference numeral 603 of FIG. 6B indicates the initial response delay after the valve command of the front wheel upon decompression, and reference numeral 604 of FIG. 6B indicates the initial response delay after the valve command of the rear wheel upon decompression.

Thus, an inter-platooning vehicle distance controller 100 of FIG. 1 may previously store delay time information after the valve command according to the front wheel/rear wheel and the compression/decompression and may use the stored delay time information.

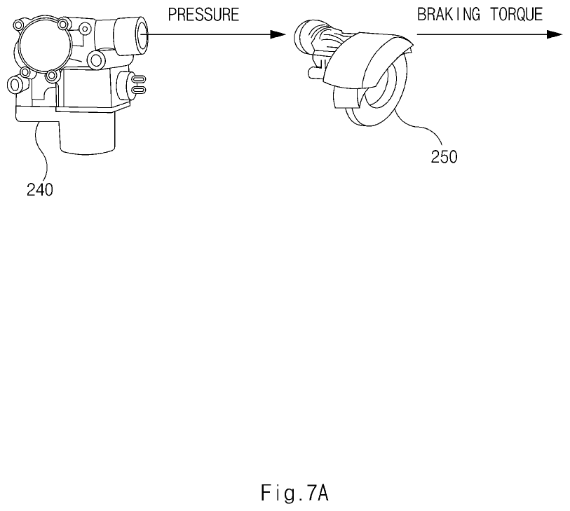

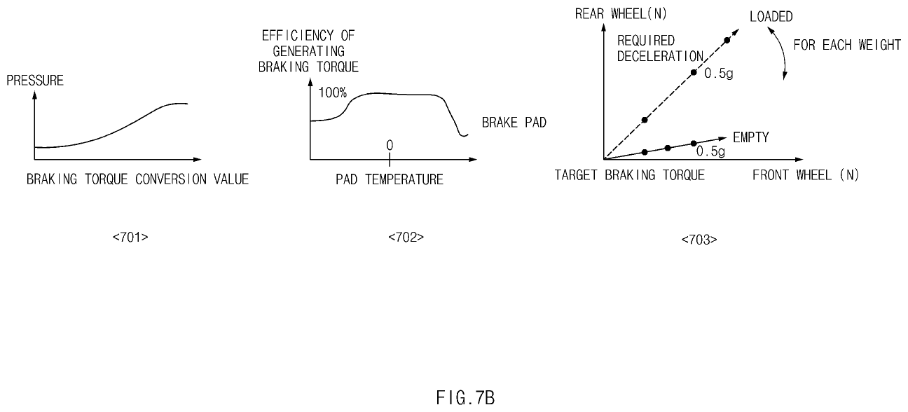

FIGS. 7A and 7B are drawings illustrating a process of calculating the efficiency of generating a braking torque according to an embodiment of the present disclosure.

Referring to FIG. 7A, a braking torque is generated using an air pressure. There is no problem because general driving control rather than platooning control is to increase braking torques of the front wheel and the real wheel at the same time without specific limit, when the braking torque is generated, and maximize a road surface coefficient of utilization although the ABS is entered to consequently ensure only a braking distance and stability.

However, when a temperature of the brake pad is high upon platooning control, as the efficiency of generating a braking torque is reduced, the changed braking torque may maximally delay ABS entry with regard to a change in weight point for each axle (on an ideal braking diagram) according to deceleration and may limit a torque of the front wheel and a torque of the rear wheel at the rate of the ideal braking diagram to maximally obtain braking linearity of each vehicle.

Equation 1 below is the formula for the ideal braking diagram and Equation 2 below is the formula for obtaining the dynamic load W_{f} of the front wheel upon braking and the dynamic load Wᵣ of the rear wheel upon braking.

$${B}_{f} = {μW}_{f} = \frac{a}{g} ( {W}_{fs} + W \cdot \frac{a}{g} \cdot \frac{h}{l} ) {B}_{r} = μ {W}_{r} = \frac{a}{g} ( {W}_{rs} - W \cdot \frac{a}{g} \cdot \frac{h}{l} ) \qquad [ Equation 1 ]$$

B_{f} denotes the braking force of the front wheel, Bᵣ denotes the braking force of the rear wheel, W denotes the vehicle weight, H denotes the height of the center of gravity, I denotes the distance between axles, and μ denotes the value obtained by dividing the acceleration “a” by the acceleration of gravity “g”.

$${W}_{r} = {W}_{rs} - W \cdot \frac{a}{g} \cdot \frac{h}{l} {W}_{f} = {W}_{fs} + W \cdot \frac{a}{g} \cdot \frac{h}{l} \qquad [ Equation 2 ]$$

For example, when the vehicle is decelerating at a deceleration of 0.3 g and when the braking force calculated by Equation 2 above is, for example, 10000 N in the front wheel and 6000 N in the rear wheel according to a vehicle characteristic value, the ratio of 5:3 may be a braking force ratio according to an ideal weight change.

When a basic design of the vehicle is to generate the same pressure (5:5) of the front and rear wheels and convert the compression into a braking torque using the same brake pad, because the braking force of the front wheel and the braking force of the rear wheel increase in the same manner when a brake pressure increases and because the front wheel performs normal general braking, but because the rear wheel exceeds the limit of braking force, from the moment the front-wheel braking force is greater than 6001 N and the rear-wheel braking force is greater than 6001 N (the ratio of 5:5), a wheel slip starts to be generated.

Thus, it may be seen that a probability that the ABS will be entered at the moment the ratio of 5:3 in the braking force is broken when the vehicle decelerates at 0.3 g. Thus, to maintain the ratio of 5:3 in the same manner at a braking torque for each axle into which pressure is converted, when the ratio of the braking torque of the front wheel to the braking torque of the rear wheel is greater than 5:3, the braking force of the rear wheel does not increase any longer to be limited and only the torque of the front wheel increases to limit amounts of torques of the front wheel and the rear wheel at the ratio of 5:3.

Reference numeral 701 of FIG. 7B is a graph illustrating a braking torque conversion value for each pressure, reference numeral 702 of FIG. 7B is a graph illustrating the efficiency of generating the braking torque for each pad temperature, and reference numeral 703 of FIG. 7B is a graph illustrating the ideal braking diagram.

An inter-platooning vehicle distance controller 100 of FIG. 1 may convert pressure into a braking torque and may multiply the changed braking torque value by braking efficiency according to a temperature of the brake pad to calculate the efficiency of generating the braking torque. When pressure is applied to the brake pad to push the rotor, the rotating rotor is stopped to generate a braking torque and heat around a portion of the pad and the rotor rises. When the vehicle is located on a polar region where the temperature at the brake pad is sharply low, performs a plurality of repeated braking, or may perform downhill braking for too long, because the brake pad rises in temperature, the temperature may fail to cause braking torques as much as the amount capable of being generated in a normal state. For example, although the same pressure is applied when the temperature of the brake pad is greater than 400 degrees, because the actual efficiency of generating a braking force is reduced, the driver presses the brake pedal deeper. A torque of 1000 Nm is generated by a pressure of 1 bar is generated upon automatically braking. However because only 800 Nm is generated due to a change in temperature, compression is needed additionally.

Thus, an inter-platooning vehicle distance controller 100 of FIG. 1 may multiply a braking torque value converted according to pressure by braking efficiency according to a pad temperature to correct the braking torque value.

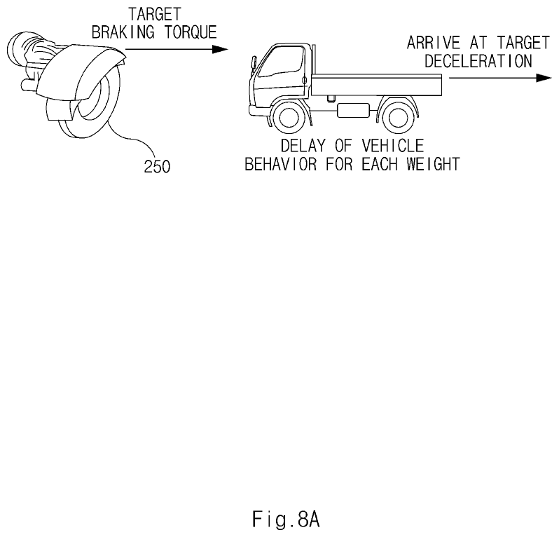

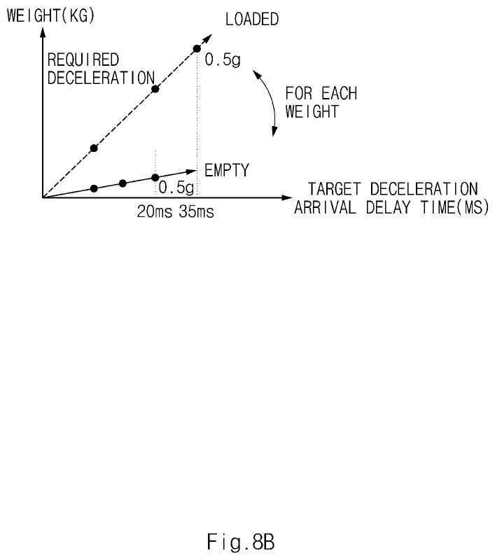

FIGS. 8A and 8B are drawings illustrating a process of calculating a delay in generating a vehicle deceleration according to an embodiment of the present disclosure.

A delay of a micro-time may occur depending on a weight of the vehicle such that a previous braking torque arrives at a target deceleration of the real vehicle. In other words, the more loaded the vehicle and the higher the required deceleration, the longer the target deceleration following time of the real vehicle according to the generated braking torque becomes. The more empty the vehicle and the lower the required deceleration, the shorter the target deceleration following time of the real vehicle according to the generated braking torque becomes.

This may cause a difference depending on a shape of an actual vehicle dynamics model of the vehicle and may map a braking torque and a delay of an actual deceleration to improve real-time accuracy of deceleration (Ax) the vehicle will generate.

In other words, as shown in FIG. 8A, a vehicle behavior for each weight may be delayed according to the target braking torque. As shown in FIG. 8B, a vehicle weight and a target deceleration arrival delay time may be measured in advance to be stored in a database.

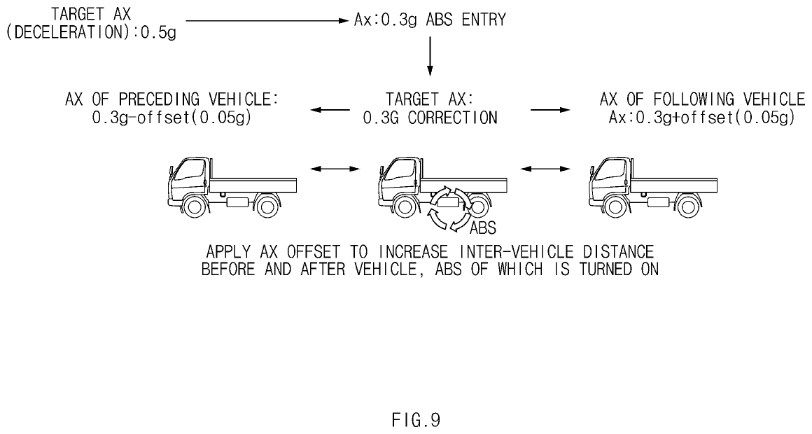

FIG. 9 is a drawing illustrating a process of calculating a safety deceleration (Ax) offset according to an embodiment of the present disclosure.

Referring to FIG. 9, when it is determined that the ABS is entered during braking, because a braking pressure is applied above the limit of the road surface, an increase in pressure and an increase in braking force are not controlled any longer in a linear manner.

Thus, an inter-platooning vehicle distance controller 100 of FIG. 1 may set a deceleration of the vehicle which enters the ABS to a target deceleration, which may control such that a preceding vehicle which enters the ABS decreases the target deceleration (−Ax offset) to decelerate less and such that a following vehicle which enters the ABS increases the target deceleration (+Ax offset) to decelerate more, thus ensuring safety of a vehicle located in a non-linear section and a vehicle before/after platooning.

For example, the inter-platooning vehicle distance controller 100 may set a target deceleration of all of platooning vehicles on the basis of a vehicle which enters the ABS, which is traveling at the lowest deceleration, when several vehicles enter their ABSs, may apply a minus offset to a preceding vehicle and may apply a plus offset to a following vehicle, on the basis of the reference vehicle, such that the preceding vehicle decelerates less and the following vehicle decelerates more, thus widening an interval between the vehicle which enters the ABS and the preceding vehicle and the following vehicle to ensure stability.

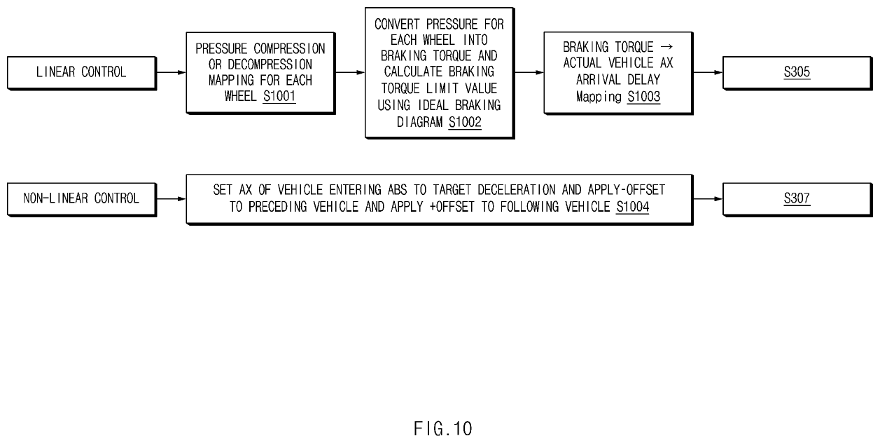

FIG. 10 is a schematic drawing illustrating a linear and non-linear control process according to an embodiment of the present disclosure.

Referring to FIG. 10, for preceding control, in S1001, an inter-platooning vehicle distance controller 100 of FIG. 1 may obtain a braking pressure generation delay time for each vehicle from a pressure generation delay time mapping value upon pressure compression or decompression for each wheel.

In S1002, the inter-platooning vehicle distance controller 100 may convert a pressure for each wheel into a braking torque and may calculate a braking torque limit value using an ideal braking diagram.

In S1003, the inter-platooning vehicle distance controller 100 may obtain a target deceleration arrival delay time for each vehicle weight from a target deceleration arrival delay time mapping value for each vehicle weight according to the braking torque.

Meanwhile, for non-linear control, in S1004, the inter-platooning vehicle distance controller 100 may correct a deceleration of the vehicle entering the ABS to a target deceleration and may control such that a preceding vehicle decreases deceleration and a following vehicle increases deceleration, thus ensuring an inter-vehicle safety distance.

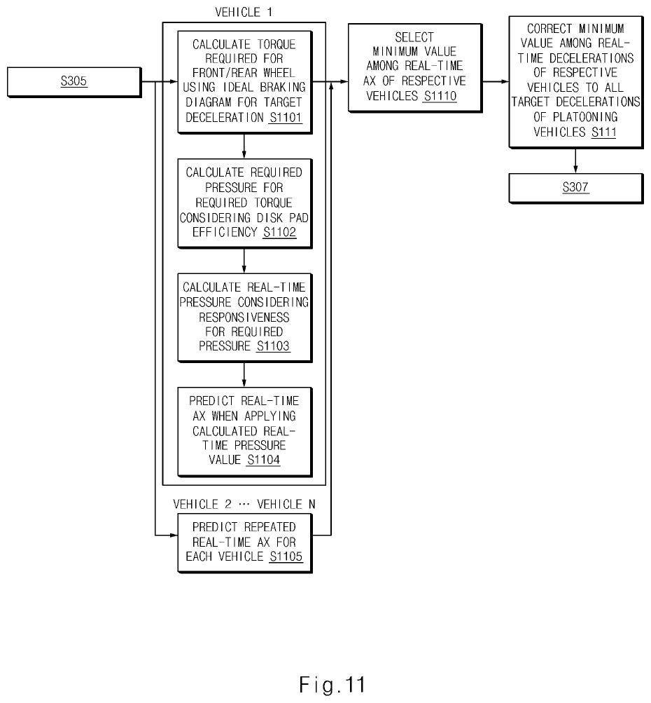

FIG. 11 is a schematic drawing illustrating a process of setting a target deceleration according to an embodiment of the present disclosure.

Referring to FIG. 11, in S1101, an inter-platooning vehicle distance controller 100 of FIG. 1 may calculate a torque required for the front wheel and a torque required for the rear wheel according to an ideal braking diagram for a target deceleration.

Furthermore, in S1102, the inter-platooning vehicle distance controller 100 may calculate a required pressure for a required torque considering a braking efficiency according to a temperature of a disk pad.

In S1103, the inter-platooning vehicle distance controller 100 may calculate a real-time pressure considering responsiveness for the required pressure.

In S1104, the inter-platooning vehicle distance controller 100 may predict a real-time deceleration when applying the calculated real-time pressure value.

In S1105, the inter-platooning vehicle distance controller 100 may predict a repeated real-time deceleration for each of the platooning vehicles.

In S1105, the inter-platooning vehicle distance controller 100 may apply the above-mentioned S1101 to S1104 to all vehicles which are platooning to predict a real-time deceleration of each of the vehicles.

In S1110, the inter-platooning vehicle distance controller 100 may select a minimum value among the real-time decelerations of the respective vehicles. In S1111, the inter-platooning vehicle distance controller 100 may correct the minimum value among the real-time decelerations of the respective vehicles to all the target decelerations of the platooning vehicles and may control to follow the target deceleration.

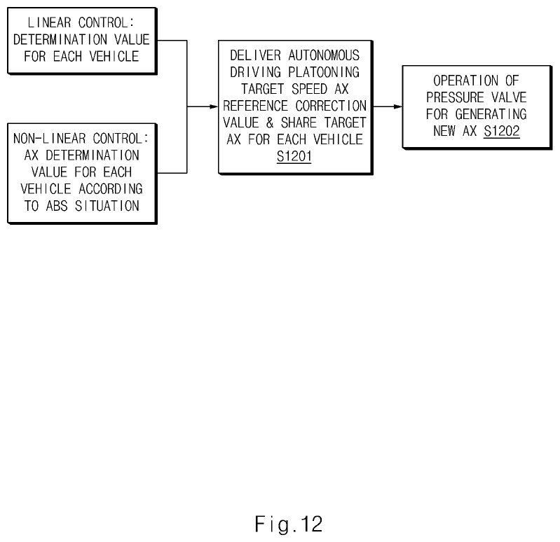

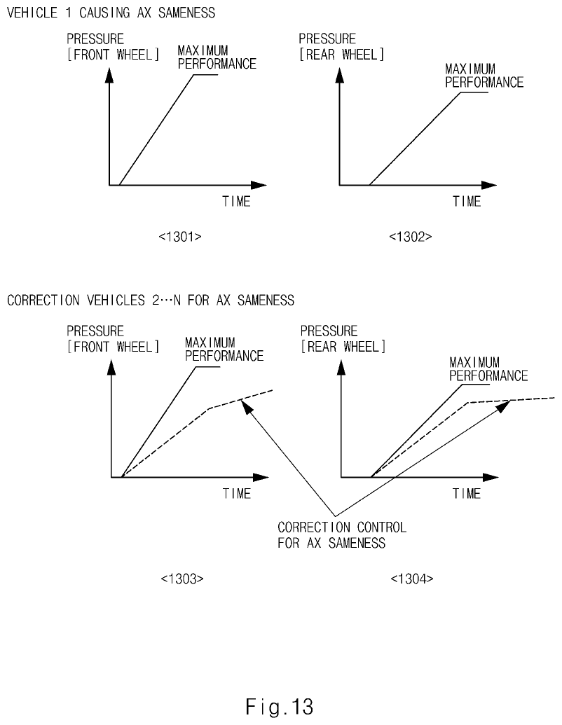

FIGS. 12 and 13 are drawings illustrating a process of controlling an operation of a pressure control valve for following a target deceleration according to an embodiment of the present disclosure.

Referring to FIG. 12, in S1201, an inter-platooning vehicle distance controller 100 of FIG. 1 may set the same target deceleration for each vehicle upon linear control and may set a different target deceleration for each vehicle upon non-linear control. In S1202, the inter-platooning vehicle distance controller 100 may control an operation of a pressure control valve for following the target deceleration.

Reference numerals 1301 and 1302 of FIG. 13 indicate the target deceleration for vehicle 1 among platooning vehicles, and reference numerals 1303 and 1304 indicate a target deceleration for vehicles 2 to N, which disclose an example of correcting the target deceleration of vehicles 2 to N to set the same target deceleration between the platooning vehicles.

As such, an embodiment of the present disclosure may predict and correct a deceleration in real time upon vehicle braking to ensure the same braking motion of all of the platooning vehicles and may separately control a linear section and a non-linear section of deceleration by means of braking force control of the platooning vehicles, thus minimizing a probability of a collision between the preceding vehicle and the following vehicle and minimizing an inter-vehicle distance.

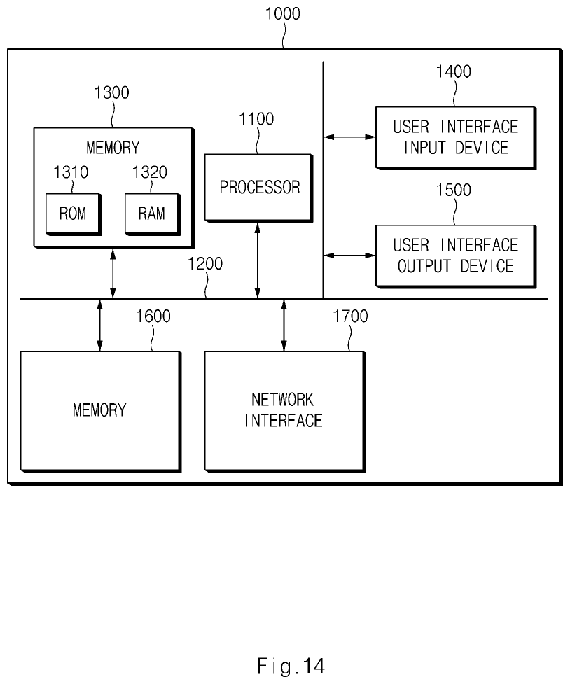

FIG. 14 is a block diagram illustrating a computing system according to an embodiment of the present disclosure.

Referring to FIG. 14, a computing system 1000 may include at least one processor 1100, a memory 1300, a user interface input device 1400, a user interface output device 1500, a memory (i.e., storage) 1600, and a network interface 1700, which are connected with each other via a bus 1200.

The processor 1100 may be a central processing unit (CPU) or a semiconductor device that processes instructions stored in the memory 1300 and/or the memory 1600. The memory 1300 and the memory 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the memory 1600) such as a RAM, a flash memory, a ROM, an EPROM, an EEPROM, a register, a hard disk, a removable disk, and a CD-ROM.

The exemplary storage medium may be coupled to the processor, and the processor may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may predict a real-time vehicle deceleration using deceleration (Ax) as a control reference factor for reducing a braking distance of a platooning vehicle and may control a pressure control valve for braking, thus minimizing an inter-vehicle distance between platooning vehicles.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An inter-platooning vehicle distance controller comprising:
a processor configured to separate a linear control section from a non-linear control section based on whether a preceding vehicle brakes during platooning, predict a real-time deceleration for each platooning vehicle with regard to a disturbance factor when generating a deceleration in the linear control section, and set target decelerations of platooning vehicles based on the predicted real-time deceleration; and
a memory configured to store data and an algorithm executable by the processor.

2. The inter-platooning vehicle distance controller of claim 1, wherein the processor is configured to determine the linear control section where deceleration increases when pressure increases, when an anti-lock brake system (ABS) of the preceding vehicle is turned off, and determine the non-linear control section where the deceleration does not increase although the pressure increases, when the ABS of the preceding vehicle is turned on.

3. The inter-platooning vehicle distance controller of claim 1, wherein the processor is configured to:
predict the deceleration using information indicating whether a platooning vehicle decelerates, an ABS flag of the platooning vehicle, information about a vehicle weight of the platooning vehicle (including a front/rear axle), information about a disk temperature of the platooning vehicle, or information about a required deceleration of the platooning vehicle; and
set the target deceleration based on the predicted deceleration.

4. The inter-platooning vehicle distance controller of claim 1, wherein the processor is configured to calculate a delay of a time taken to generate a braking pressure for each vehicle, in the linear control section.

5. The inter-platooning vehicle distance controller of claim 4, wherein the processor is configured to convert the braking pressure for each vehicle into a braking torque to calculate braking torque conversion efficiency.

6. The inter-platooning vehicle distance controller of claim 5, wherein the processor is configured to apply an ideal braking diagram to the braking torque to limit torques of a front wheel and a rear wheel and predict the deceleration.

7. The inter-platooning vehicle distance controller of claim 5, wherein the processor is configured to multiply the braking torque by braking efficiency according to pressure for each brake pad temperature to calculate the braking torque conversion efficiency.

8. The inter-platooning vehicle distance controller of claim 5, wherein the processor is configured to calculate a delay time of an actual vehicle deceleration compared to a required deceleration according to a vehicle weight.

9. The inter-platooning vehicle distance controller of claim 8, wherein the processor is configured to predict real-time decelerations of the platooning vehicles using a braking pressure generation delay time for each vehicle, the efficiency of generating the braking torque, or a deceleration arrival delay time for each vehicle weight.

10. The inter-platooning vehicle distance controller of claim 8, wherein the processor is configured to set a smallest value among real-time decelerations of the platooning vehicles to the target decelerations of the platooning vehicles.

11. The inter-platooning vehicle distance controller of claim 1, wherein the processor is configured to set the target decelerations of the platooning vehicles to the same value.

12. The inter-platooning vehicle distance controller of claim 1, wherein the processor is configured to set a deceleration of the preceding vehicle to a target deceleration of a host vehicle, in the non-linear control section, add an offset to a target deceleration of the preceding vehicle, and subtract the offset from a target deceleration of a following vehicle to set the target decelerations of the platooning vehicles.

13. The inter-platooning vehicle distance controller of claim 1, wherein the processor is configured to control an inter-vehicle distance between the preceding vehicle and a host vehicle in a direction where the inter-vehicle distance increases, in the non-linear control section.

14. The inter-platooning vehicle distance controller of claim 1, wherein the processor is configured to calculate a required torque of a front wheel and a required torque of a rear wheel based on an ideal braking diagram for a target deceleration, calculate a required pressure for the required torque considering braking efficiency of a brake pad, calculate a real-time pressure for the required pressure, and predict a real-time deceleration for each platooning vehicle using the calculated real-time pressure value.

15. The inter-platooning vehicle distance controller of claim 1, wherein the memory is configured to store a braking pressure generation delay time mapping value for each vehicle, a braking torque mapping value for each pressure, or a deceleration arrival delay time mapping value for each vehicle weight.

16. The inter-platooning vehicle distance controller of claim 15, wherein the processor is configured to obtain a delay of a time taken to generate a braking pressure for each vehicle from the braking pressure generation delay time mapping value for each vehicle and obtain a deceleration arrival delay time for each vehicle weight from the deceleration arrival delay time mapping value for each vehicle weight.

17. The inter-platooning vehicle distance controller of claim 1, wherein the disturbance factor includes a non-linear braking force section where an increase in braking torque does not refer to an increase in vehicle deceleration, a delay in applying a braking force according to hardware responsiveness, degradation in braking force due to heat, or a change in weight points of a front axle and a rear axle of a vehicle upon braking.

18. A vehicle system comprising:
an inter-platooning vehicle distance controller configured to separate a linear control section from a non-linear control section based on whether a preceding vehicle brakes during platooning, predict a real-time deceleration for each platooning vehicle with regard to a disturbance factor when generating a deceleration in the linear control section, and set target decelerations of the platooning vehicles based on the predicted real-time deceleration; and
a pressure control valve configured to be controlled by the inter-platooning vehicle distance controller to control an air pressure applied from an air tank to a disk.

19. An inter-platooning vehicle distance control method, the method comprising:
separating a linear control section from a non-linear control section based on whether a preceding vehicle brakes during platooning;
predicting a real-time deceleration for each platooning vehicle with regard to a disturbance factor when generating a deceleration in the linear control section; and
setting target decelerations of the platooning vehicles based on the predicted real-time deceleration.

20. The method of claim 19, wherein separating the linear control section from the non-linear control section comprises:
determining the linear control section where deceleration increases when pressure increases, when an anti-lock brake system (ABS) of the preceding vehicle is turned off; and
determining the non-linear control section where the deceleration does not increase although the pressure increases, when the ABS of the preceding vehicle is turned on.
